(19) United States
(12) Patent Application Publication
(10) Pub. No.: US 2008/0283505 A1
(43) Pub. Date: Nov. 20, 2008

(54) Welding torch cable strain relief system and method

(75) Inventors: Mark Richard Christopher, Neenah, WI (US); Kenneth J. Puls, Appleton, WI (US)

Correspondence Address: FLETCHER YODER (ILLINOIS TOOL WORKS INC.), P.O. BOX 692289, HOUSTON, TX, 77269-2289, US

(73) Assignee: Illinois Tool Works Inc.

(21) Appl. No.: 11/803,513

(22) Filed: May 15, 2007

(51) Int. Cl. B23K 9/32

(52) U.S. Cl. 219/74

(57) ABSTRACT

Conduits exiting from a welding torch handle are supported by a stiffening arrangement to limit the angle or radius of curvature of the conduits and thereby to limit strain and possible damage. The stiffening arrangement may include a stiffener that does not extend completely around the conduits, but is captured in a jacket that may be secured to the torch handle and wrapped around the conduits. Alternatively, an integral stiffener or stiffener assembly may include a tongue-like-stiffener extending from the handle to support the conduits and to limit their radius of curvature as they exit the handle.

### BACKGROUND

The present invention relates generally to the field of welding systems and welding apparatus. More particularly, the invention relates to a technique for avoiding damage to welding supply conduits coupled to welding torches.

A wide range of applications are known for various welding systems. In general, arc welding systems produce a weld by passing an AC or DC current through an electrode and a workpiece. The voltage applied between these components forms an arc which heats the electrode and the workpiece. In certain applications, such as metal inert gas (MIG) welding, a continuous feed of wire electrode is directed to the location where the arc is established. The wire is melted, along with materials in the neighborhood of the desired weld, to produce a weld bead. The arc and bead may be protected by gasses, fluxes, and so forth, depending upon the particular welding technique employed.

In welding systems, such as the MIG systems discussed above, various supply conduits are connected to the welding torch from which the electrode exits. These include a power supply conduit for supplying the necessary electrical power for the arc. Moreover, where gas shielding is employed, a gas supply conduit is provided that directs a flow of gas from a gas supply through the torch to a location adjacent to the progressing weld. In continuous feed wire systems, a wire electrode conduit provides for the advance of wire from a wire source to the torch. In certain systems, a cooling fluid may be channeled through yet another conduit to the torch.

A persistent problem in such welding applications is the weight of these supply conduits, and the consequent tendency of the conduits to droop as they exit the welding torch. Supply conduits are often tied to one another by various wraps or ties, and may be at least partially shielded by jackets. However, these do not provide sufficient rigidity to avoid straining the conduits over extended periods of use and large numbers of cycles of flexure. Ultimately, the conduits may become damaged or even kink due to an excessively steep angle or radius of curvature at the point where they exit the torch and lead back to the welding supply sources.

While certain arrangements may reduce this angle or radius, these also present other drawbacks. For example, a helix of relatively rigid wire may surround a portion of the conduits as they exit the welding torch in a spring-like configuration. While this does effectively reduce the angle at which the conduits exit the welding torch, such arrangements make it extremely difficult to service the conduits. That is, connections made between the conduits and the torch are relatively inaccessible beneath the wire spiral, which must be removed or displaced to access fittings when servicing the torch or conduits.

There is a need, therefore, for improved approaches to strain relief in welding torch applications. There is a particular need for techniques that will avoid damage to welding torch supply conduits while allowing for easy access to the conduits and to fittings attaching the conduit to the welding torch when needed.

### BRIEF DESCRIPTION

The present invention provides a novel technique for avoiding or reducing strain in welding torch supply conduits designed to respond to such needs. The technique makes use of a stiffener that is disposed adjacent to conduits exiting a welding torch. The stiffener may be housed in a jacket that may be wrapped around the conduits. The jacket may be held closely adjacent to the welding torch by various mechanisms, such that the stiffener remains in place. The stiffener may also be incorporated, such as by molding, into an extension of the welding torch handle.

The stiffener, in the various embodiments presently contemplated, does not hamper or encumber the supply conduits or their connections. For example, in the case of a jacket-mounted stiffener, the jacket can be easily removed or withdrawn to expose the conduits and their connections to the torch. Where an integral stiffener is provided, the conduits and their connection can be easily exposed, and the conduits can be freed from the stiffener by removal of any suitable attachment mechanism, such as bands or ties.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an exemplary welding torch having supply conduits and a stiffening arrangement for controlling the curvature of the conduits as they exit the torch in accordance with aspects of the present invention;

FIG. 2 is an elevational view of the torch of FIG. 1 showing how the stiffening arrangement may be mounted;

FIG. 3 is a view of the same torch as shown in FIG. 2 with the stiffening arrangement secured in place to limit the curvature of the conduits as they exit the torch handle;

FIG. 4 is a sectional view through the arrangement of FIG. 3 illustrating how an exemplary jacket-type stiffening arrangement may be wrapped around the welding supply conduits;

FIG. 5 is an elevational view showing an exemplary jacket-type stiffening arrangement corresponding to that employed in the previous figures;

FIG. 6 is an elevational view of an exemplary stiffener designed for use in the jacket-type arrangement of FIG. 5;

FIG. 7 is a perspective view of a molded extension for a welding handle incorporating an integral stiffener;

FIG. 8 is an elevational view of a portion of a welding torch and welding supply conduits secured to the stiffener shown in FIG. 7; and

FIG. 9 is a rear elevational view of the stiffener and conduits of FIG. 8.

### DETAILED DESCRIPTION

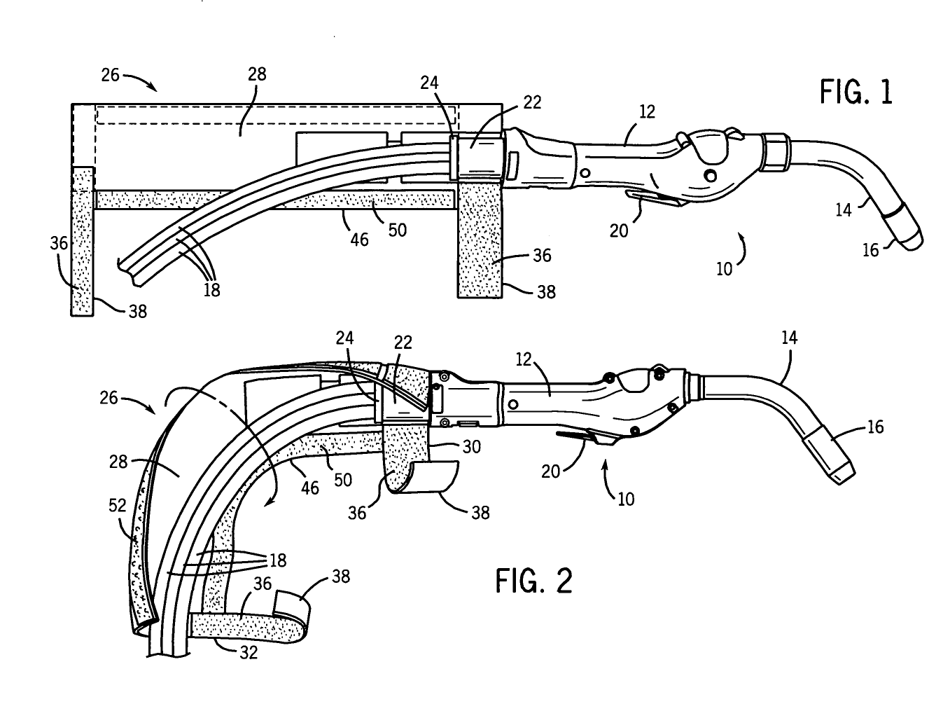

Turning now to the drawings, and referring first to FIG. 1, a welding torch is illustrated and designated generally by reference numeral 10. As will be appreciated by those skilled in the art, the torch, when placed in service, will be coupled to a source of welding power, as well as to other resources, such as a source of continuous wire electrode. The wire electrode and power source are typically provided in a welding base unit (not shown) which may be designed for drawing electrical power from the power grid or from a mobile power sources, such as an engine-driven generator (not shown). The welding resources, in the illustrated embodiment, may also typically include a source of inert gas which can be used to surround the electrode and weld during the welding operation. The illustrated welding torch is designed for MIG welding, such as with different sizes and grades of aluminum electrode wire.

The welding torch 10 shown in FIG. 1 has a body or handle 12 that terminates in a neck 14 and tip 16. In general, the welding resources, including the wire electrode, electrical power, and any shielding media will be delivered by a series of conduits 18 coupled to a rear end of the handle 12 opposite the neck 14 and tip 16. As will be appreciated by those skilled in the art, electrical current is conducted through one of these conduits, while the wire electrode passes through another. In certain applications, such as where steel electrode wires are used, a remote wire drive system may push wire through the conduit and torch. In other applications, such as that illustrated, other wires such as aluminum wires, may be captured between rollers within the torch handle which apply a drive pressure to the electrode sufficient to draw the electrode from a remote spool (not shown), through the handle, and to force the electrode through the neck 14 and tip 16. Within the tip 16, a contact tip (not shown) will contact the electrode and apply the welding current to it prior to exiting the torch. Ultimately, the electrode will exit the torch at the location of a desired weld joint.

As will be appreciated by those skilled in the art, to control the advancement of the welding electrode, and the application of electrical power to the electrode, and the flow of shielding media, where provided, the torch 10 is provided with a trigger 20. The trigger, which is spring biased to an OFF position can be depressed to close an internal switch within the torch that activates the supply of welding resources. In particular, the switch (not shown) will energize an electric motor that drives the electrode toward the torch tip.

On a side of the torch handle opposite the neck 14 and tip 16, an extension 22 is provided from which the conduits 18 extend. In the illustrated embodiment, this extension may be part of the shell surrounding the handle which is grasped by the welder, or it may be a separate item that is added to the rear end of the handle. A flange 24 may be provided on this extension to assist in the retention of a stiffening jacket 26 in accordance with certain embodiments of the invention. In the embodiment illustrated in FIG. 1, the stiffening jacket 26 is a flexible jacket made of a material that will resist wear and hot materials that may splatter on the jacket from time to time. A presently contemplated material is leather. The jacket itself is made up of a panel 28 having an end 30 disposed adjacent to the torch and an end 32 distal from the torch and wrapped around the conduits when the jacket is installed. Hook and loop fastening systems, or any other suitable fastening system, may be used to secure the stiffening jacket to the torch and conduits. In the illustrated embodiment, and as described more fully below, strips of hook fastener material 34 and loop fastener material 36 are sewn to the panel, and to straps 38 extending from the panel to permit the jacket to be secured to the torch handle and around the conduits.

FIG. 2 illustrates the torch of FIG. 1 and an exemplary manner for mounting the stiffening jacket around the conduits. As shown in FIG. 2, the jacket may be disposed immediately adjacent to the rear of the handle, and wrapped around the extension 22. Thereafter, the strap 38 formed at the proximate end 30 can be wrapped securely around the end of the panel 28 and the hook and loop fastening system pressed into contact to hold the jacket securely around the extension 22. Similarly, the distal end 32 may be wrapped around the conduits 18, and the body of the jacket will be similarly wrapped around portions of the conduits between these ends.

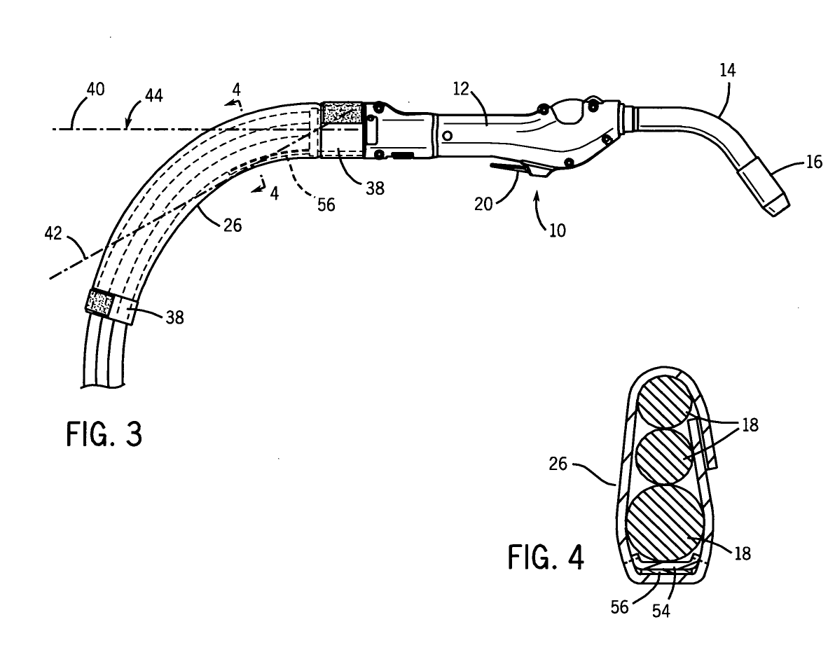

FIG. 3 illustrates the stiffening jacket after this installation. As described more fully below, the jacket includes a stiffener built into a pocket or other section of the panel that permits limited mobility of the conduits, and particularly limits the radius of curvature or the angle at which the conduits can exit the torch handle. As can be seen in FIG. 3, the conduits will exit the torch handle generally along an axis 40 of the handle. The stiffener and conduits, together, within the stiffening jacket 26 will be limited in the radius that can be formed between this axis and the point where the conduits exit the jacket, or at least a point where the conduits are no longer supported by the internal stiffener described below. Thus, at some point along the conduits and jacket, a tangent line 42 may be drawn that defines an angle 44 with the axis 40. This angle is limited by the natural rigidity of the stiffener described below. As noted above, and as best illustrated in the sectional view of FIG. 4, when the jacket 26 is wrapped around the conduits 18, the conduits will be held in a tight bundle and will move together with the radius of curvature of the conduits exiting the handle limited by the stiffener. The position, nature and operation of the stiffener, represented by reference numeral 56, will be discussed in greater detail below.

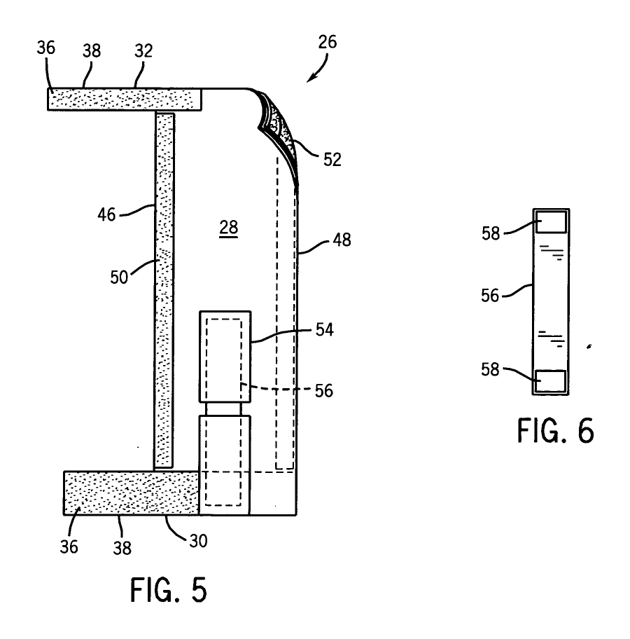

An exemplary embodiment of the stiffening jacket 26 is illustrated in FIG. 5. As discussed above, the jacket may be made of any suitable material, such as various fabrics, leather, and so forth. In general, it will be helpful that the jacket is made of a durable material that can resist burning and damage due to the occasional heat and splatter that may be possible in the vicinity of the weld. The panel 28 is bound by ends 30 and 32. In a presently contemplated embodiment, the panel is approximately 17 inches in length and approximately 5 to 6 inches in width, although other dimensions may, of course, be accommodated. A hook-end-loop fastener system is used to secure the jacket around the extension of the welding handle and around the conduits. In particular, in the embodiment illustrated in FIG. 5, straps 38 have a loop fastener panel sewn to one side thereof, which interfaces with hook fastener panels 34 disposed on a reverse side of panel 28 near ends 30 and 32. To allow the jacket to be secured along its length, edges 46 and 48 are similarly provided with hook-and-loop fastener strips. In particular, in the illustrated embodiment, loop closure panels are provided along edge 46 as indicated by reference numeral 50, while hook fastener panels 52 are sewn along an opposite side of edge 48. Thus, when the panel is wrapped around the end of the torch and the conduits, the edges and ends may be tightened around the conduit and held firmly in place.

In the embodiment of FIG. 5, a pocket 54 is formed adjacent to end 30 to receive a stiffener 56. The pocket may be sewn into the material of panel 28, and may permanently or temporarily capture the stiffener between layers of material. The pocket holds the stiffener in place, to allow the stiffener to be disposed adjacent to the rear end of the torch. In the presently contemplated embodiment, the stiffener will be positioned beneath the conduits when viewed in the elevational views discussed above. That is, when the torch is held with the neck and tip pointing downwardly towards a weld, the stiffener would support the conduits from a bottom side. However, it should be understood that because the jacket is wrapped snuggly around the conduits, the stiffener effectively prevents or limits strain on the conduits as they exit the torch independent of the orientation of the torch. An exemplary stiffener is illustrated in FIG. 6, and may be made of any suitable material, such as spring steel. Anti-abrasion elements, such as tape 58 may be positioned on either end of the stiffener to avoid excessive abrasion within the pocket of the jacket.

It should be noted that when installed, the jacket and stiffener completely surround and support the conduits as they exit the torch handle. However, the stiffener itself does not completely surround the conduits, and can be easily removed from the conduits with the jacket for servicing the torch, accessing connections between the conduits and the torch handle, and so forth.

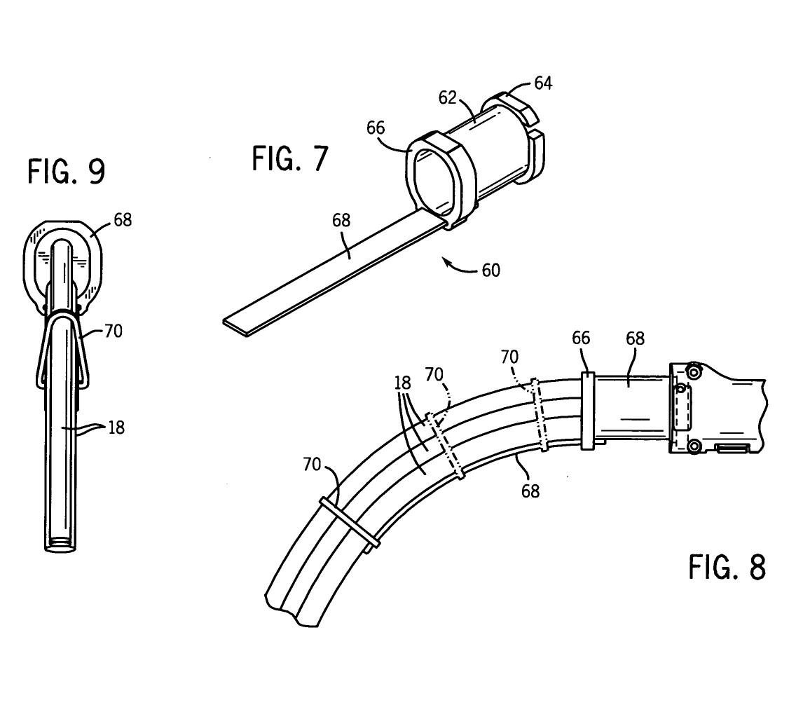

In a presently contemplated alternative configuration, illustrated generally in FIG. 7, a stiffener may be formed integrally with the torch handle or an extension thereof. As shown in FIG. 7, a molded stiffener extension 60 may include an extension 62 similar to extension 22 described above. The extension may be bounded by flanges 64 and 66 that enable the extension to be assembled with and held snuggly by the outer shell of the torch handle. Conduits (not shown in FIG. 7) may then pass through the stiffener extension and over an integral stiffener 68. This tongue-like stiffener is formed integrally with the extension, or the two parts may be joined in a molding process, such as an over-molding or insert process. The integral stiffener 68 then extends from the extension to support the conduits in a manner similar to stiffener 56 described above.

FIGS. 8 and 9 illustrate the molded stiffener extension and integral stiffener 68 in use. As shown in FIG. 8, the conduits 18 will exit the extension through the rear flange 66. The conduits will be disposed adjacent to the stiffener 68 which supports the conduits and reduces the allowed radius of curvature or angle of droop as the conduits exit the torch handle. In this embodiment, a jacket may also be placed over the conduits, or the conduits may simply be secured to the extension by means of straps or ties 70. FIG. 9 is a rear view of the same assembly, illustrating the conduits descending from the extension and wrapped with one or more ties to help maintain the conduits and stiffener in close association with one another.

Although not specifically illustrated in these various embodiments, it should be noted that the stiffening arrangements provided by the invention may be used with various types of welding torches. For example, the same or similar arrangements may be used with torches on which a spool of wire is held (rather then located on a more distant reel). Torches of this type are available, for example from Miller Electric of Appleton, Wis., under the commercial designation “Spoolmatic”. Moreover, the invention may be utilized with as few as a single conduit, or with multiple conduits as described above. Other conduits may also be supported by the inventive arrangements, such as conduits designed to transmit cooling fluids to the welding torch. In particular, welding torches with stranded electrical conductors for delivering welding power from a power supply will particularly benefit from the invention, even if such conductors or cables are the only conduits supported by the stiffening arrangement. It has been found that such stranded conductors may tend to fatigue, become overheated due to resistive losses, and eventually break under the loading and cycling of conventional arrangements. The reduction in the angle or radius of curvature of such conductors, offered by the invention, will significantly increase their useful lives.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A welding torch comprising:
a torch handle;
a plurality of supply conduits extending from the handle;
a stiffener disposed adjacent to the supply conduits and only partially surrounding the conduits, the stiffener reducing an arc or curvature of the conduits near the handle; and
a securement member extending around the conduits and the stiffener to maintain the stiffener in a position adjacent to the conduits.

2. The welding torch of claim 1, wherein the stiffener is molded to an extension of the handle.

3. The welding torch of claim 1, wherein the stiffener is a flexible metallic element.

4. The welding torch of claim 1, wherein the securement member includes a jacket configured to be wrapped around the conduits, the stiffener being disposed in the jacket.

5. The welding torch of claim 4, wherein the jacket extends fully around the conduits.

6. The welding torch of claim 5, wherein the jacket is removably secured to the torch handle by hook and loop fasteners.

7. The welding torch of claim 4, wherein the stiffener is removably disposed in a pocket formed in the jacket.

8. The welding torch of claim 1, wherein the securement member includes a strap.

9. A welding torch comprising:
a torch handle, the torch handle having an extension on a rear end thereof;
a plurality of supply conduits extending from the handle;
a stiffener molded to the extension and disposed adjacent to the supply conduits and only partially surrounding the conduits, the stiffener reducing an arc or curvature of the conduits near the handle; and
a securement member extending around the conduits and the stiffener to maintain the stiffener in a position adjacent to the conduits.

10. The welding torch of claim 9, wherein the securement member is a flat, tongue-like projection of the extension.

11. The welding torch of claim 9, wherein the extension is molded as a separate piece from the handle.

12. The welding torch of claim 9, wherein the securement member includes a strap.

13. A welding torch comprising:
a torch handle;
a plurality of supply conduits extending from the handle; and
a jacket configured to be wrapped around the conduits, the jacket including a stiffener disposed adjacent to the supply conduits and only partially surrounding the conduits, the stiffener reducing an arc or curvature of the conduits near the handle.

14. The welding torch of claim 13, wherein the stiffener is a flexible metallic element.

15. The welding torch of claim 13, wherein the jacket extends fully around the conduits.

16. The welding torch of claim 13, wherein the jacket is removably secured to the torch handle by hook and loop fasteners.

17. The welding torch of claim 13, wherein the stiffener is removably disposed in a pocket formed in the jacket.

18. A welding torch conduit stiffening device comprising:
a jacket configured to be wrapped around conduits extending from a welding torch; and
a stiffener disposed in the jacket in a position such that the stiffener will be adjacent to the conduits and only partially surrounding the conduits when the jacket is wrapped around the conduits.

19. The device of claim 18, wherein the jacket includes hook and loop fasteners for removably securing the jacket to a torch handle.

20. The device of claim 18, wherein the stiffener is removably disposed in a pocket formed in the jacket.

21. The device of claim 18, wherein the stiffener is a flexible metallic element.
